(19) United States
(12) Patent Application Publication
(10) Pub. No.: US 2025/0033879 A1
(43) Pub. Date: Jan. 30, 2025

(54) ASSEMBLED LOAD HANDLING DEVICE FOR AUTOMATED WAREHOUSES

(71) Applicant: AUTOMHA S.P.A., Azzano San Paolo (Bergamo) (IT)

(72) Inventors: Walter DANNE, Azzano San Paolo (Bergamo) (IT); Paolo DEL POPOLO, Azzano San Paolo (Bergamo) (IT)

(21) Appl. No.: 18/710,647

(22) PCT Filed: Nov. 17, 2022
(86) PCT No.: PCT/IB2022/061077

§ 371 Date: May 16, 2024

(30) Foreign Application Priority Data
Nov. 19, 2021 (IT) 102021000029291

(51) Int. Cl. B65G 1/04; B61C 9/48; B61D 17/04

(52) U.S. Cl. CPC B65G 1/0492; B61C 9/48; B61D 17/04

(57) ABSTRACT

Provided is a load handling device for automatically storing a load a in a warehouse having a base frame onto which wheels are rotatably connected. The wheels are suitable for allowing a translation of the load handling device along a storage aisle of the warehouse. First handling members, arranged inside the base frame in an inner compartment, are operatively connected to one or more of the wheels. One or more operational portions define a temporary support plane for the load. Second handling members, arranged inside the base frame, are operatively connected to the one or more operational portions for moving the one or more operational portions between a base position and a lifting position. The base frame consists of sheet elements made of stainless steel mutually joined by gluing and by repositionable fixings.

### FIELD OF APPLICATION

The present invention falls within the field of the production of automated systems for the storage of items on pallets in an automated warehouse.

In particular, the present invention relates to a load handling device, in particular for handling pallets containing articles, for automated warehouses.

### PRIOR ART

Automated warehouses structured to allow the automatic storage of pallets are known in the art.

From a design point of view, these warehouses normally employ load-bearing structures comprising a structure with shoulders and uprights that defines a plurality of storage aisles of variable dimensions as a function of the expected loads. The pallets are arranged and picked up along/from such aisles through automated devices, called satellites or shuttles. In practice, these devices deposit, automatically and in series, a plurality of pallets on support guides arranged along the storage aisle. In more detail, this deposit normally takes place starting from one end of an aisle or in any case from the first free position identified within the aisle itself.

In order to perform the operations for which it is intended, the satellite normally comprises a frame provided with a plurality of wheels so as to allow the satellite to be translated along the storage aisle.

These wheels are actuated by suitable handling means which generally consist of electric motors, which are operatively controlled by command and control means and which are powered by suitable power supply means, such as batteries.

The satellite further comprises a platform suitable for providing a support surface for the pallet, as well as position detection means suitable for determining the position of the satellite in one or more points of the aisle, or means for detecting the position in a continuous manner, for example by means of laser position detection systems.

The devices of the prior art, made up to now, provide for the frame on which the wheels are hinged and which supports the motors and the control unit to be designed in such a way as to support the heavy loads, both static and dynamic, and the fatigue loads that the satellite encounters during its operation. Given the extreme working conditions, in order to guarantee adequate strength and reliability, all the frames are therefore designed in single pieces or in heavy iron plates welded together and painted to guarantee resistance to corrosion even in aggressive environments, such as refrigerating rooms.

However, the aforesaid peculiarities of the prior art devices involve numerous drawbacks: a high weight of the device, large dimensions, construction complexity, the need for large storage volumes of the frames during construction and limited ease and efficiency in transporting the devices from the production site to the installation site.

### DISCLOSURE OF THE INVENTION

The need to remedy the aforementioned drawbacks relating to the prior art is therefore strongly felt.

In particular, an object of the present invention is to provide a load handling device which is at the same time robust and easy to manufacture, and which allows improved efficiency and ease of transport.

This object is achieved by a load handling device according to the accompanying independent claims. The dependent claims describe preferred embodiments.

### BRIEF DESCRIPTION OF THE DRAWINGS

The features and advantages of the load handling device according to the present invention will appear more clearly from the following description, made by way of an indicative and non-limiting example according to the accompanying figures, wherein:

FIG. 1 shows a perspective view of an automated storage system according to an embodiment of this invention;

FIG. 2 shows a front perspective view of a portion of an automated storage system according to an embodiment of this invention;

FIG. 3 shows a perspective view of a detail portion of an automated storage system according to an embodiment of the present invention, wherein a load handling device is shown in a first operating position on a master vehicle;

FIG. 4 shows a perspective view of a detail portion of an automated storage system according to an embodiment of the present invention, wherein a load handling device is shown in a second operating position, inside an aisle of the system, unloaded from the master vehicle;

FIG. 5 shows an axonometric view of a load handling device according to an embodiment of the present invention, wherein the upper cover has been fictitiously removed to allow the view of the internal components;

FIG. 6 shows an axonometric view of the load handling device of FIG. 5, in which some components have been removed for greater clarity and visibility of the base frame;

FIG. 7 shows a bottom plan view of the load handling device of FIG. 6;

FIG. 8 shows an axonometric exploded view of the base frame of a load handling device according to an embodiment of this invention;

FIG. 9 shows an axonometric view of a portion of a load handling device according to an embodiment of this invention, in which a measuring wheel is shown;

FIG. 10 shows an enlargement of the detail Q shown in FIG. 9.

### DETAILED DESCRIPTION

Despite the present invention is described below with reference to preferred embodiments shown in the drawings, the present invention is not limited to the embodiments described below and shown in the drawings. On the contrary, the described and represented embodiments clarify some aspects of the present invention.

The present invention has proved to be particularly advantageous with reference to the implementation of a load handling device suitable for moving within a warehouse in an autonomous/semi-autonomous and preferably self-powered manner, as better described hereinafter.

However, it should be pointed out that the present invention is not limited to the implementation of an autonomous and self-powered device. On the contrary, the present invention finds convenient application in all cases involving the use of a device which moves within a suitably powered warehouse, for example a power supply system on fixed guides on which the device rests.

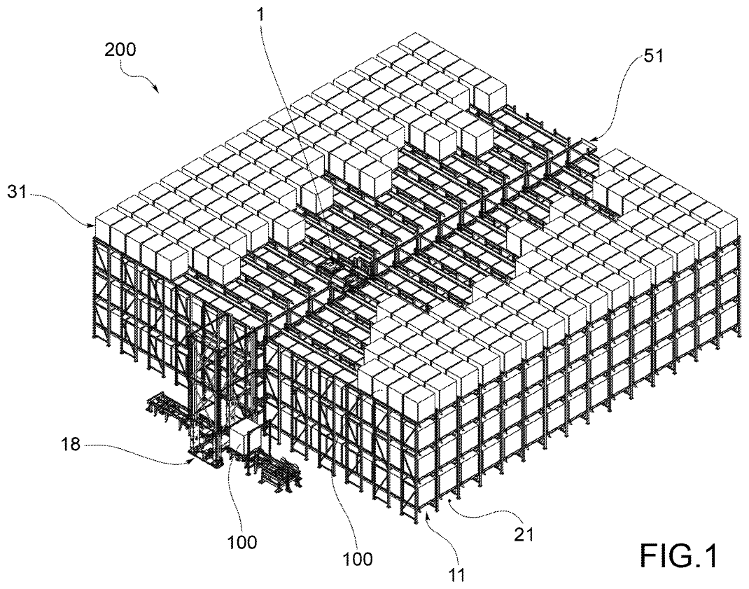

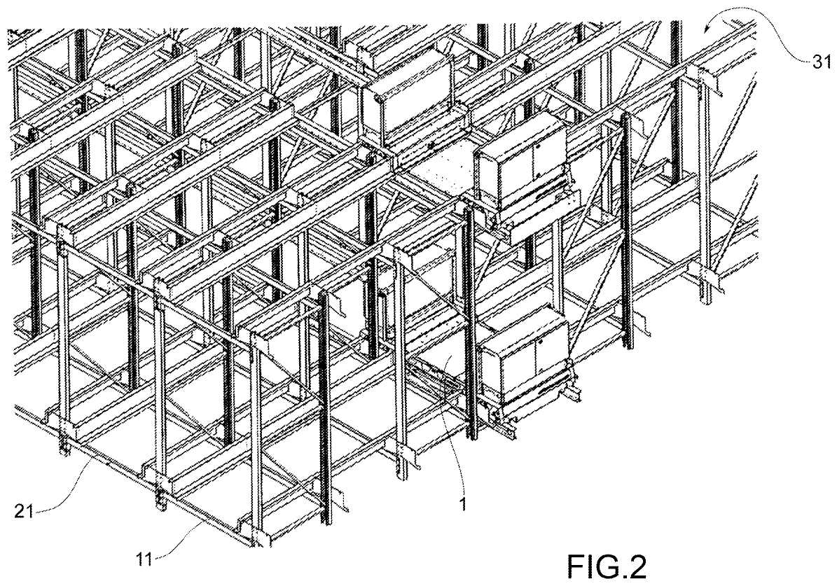

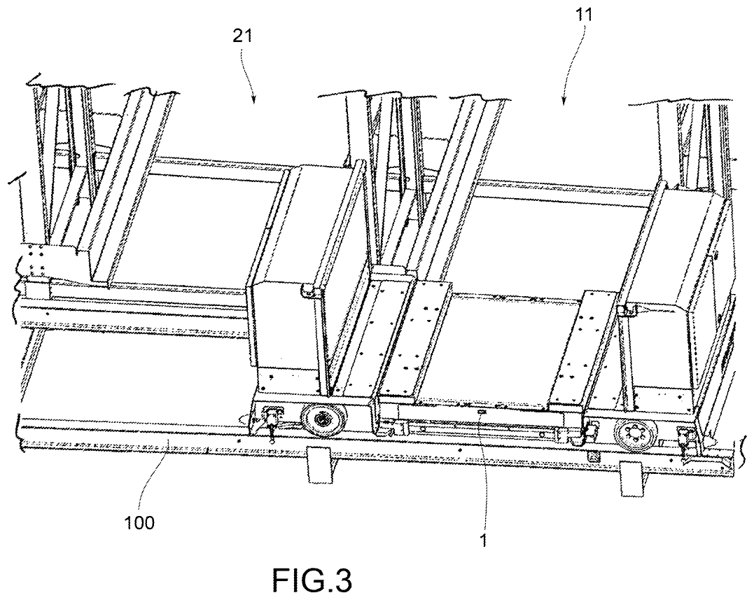

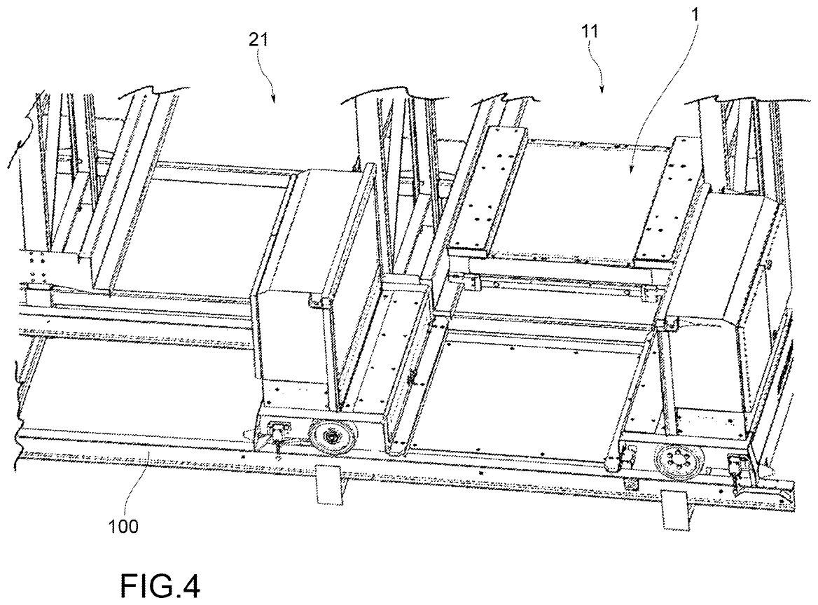

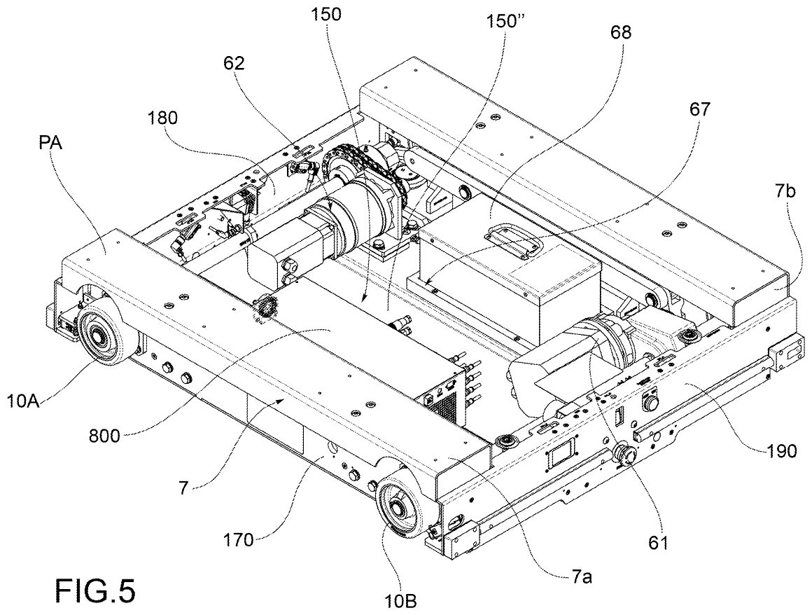

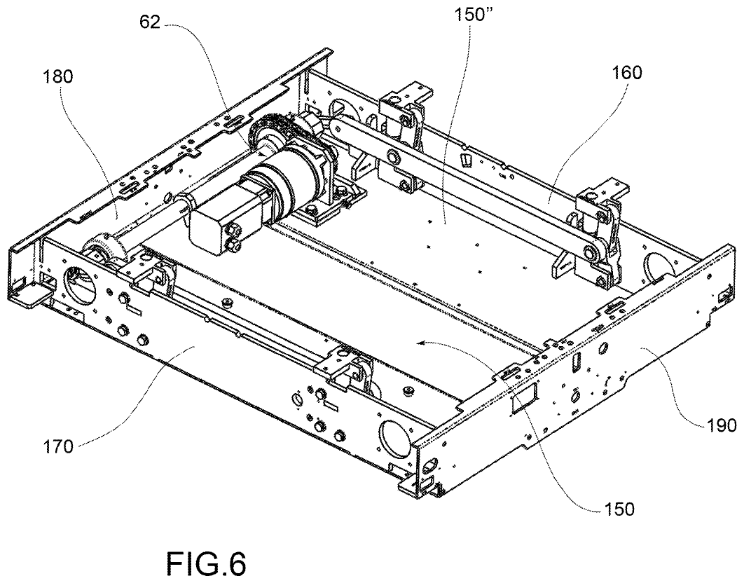

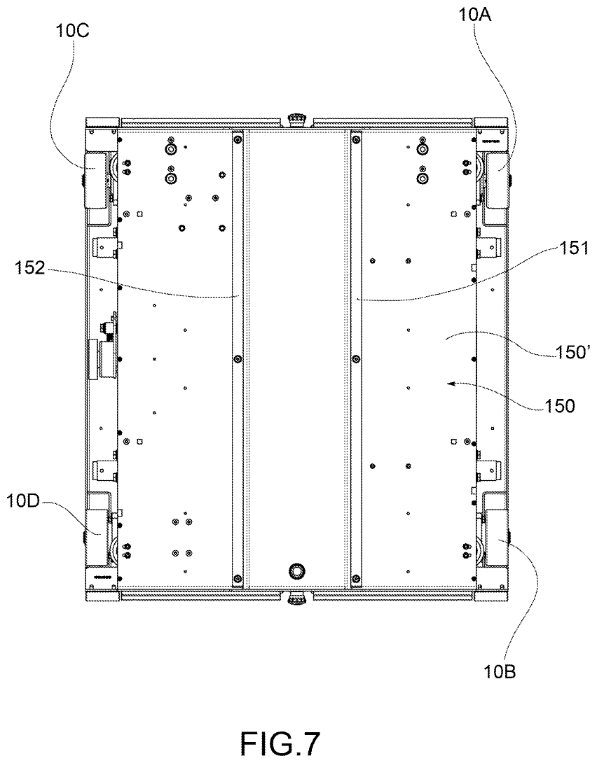

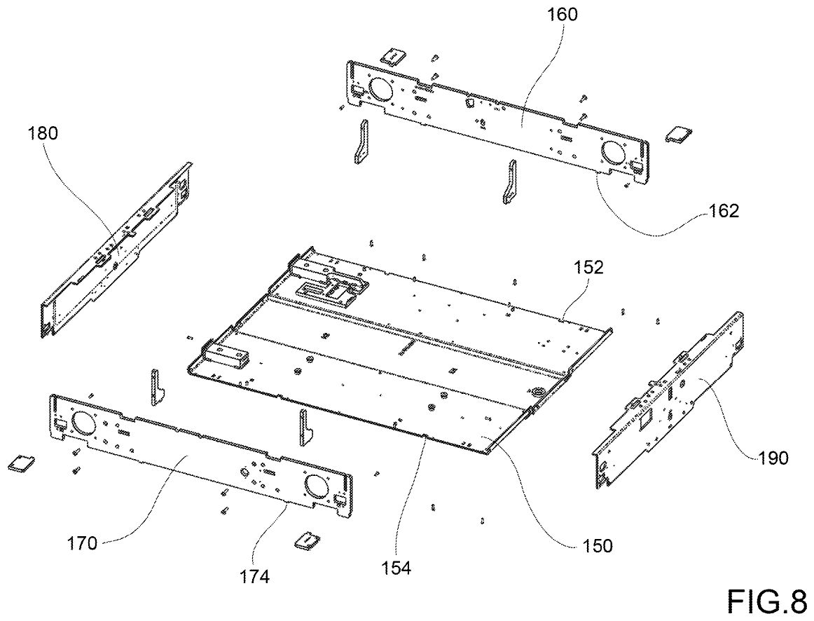

FIG. 1 schematically shows a warehouse 200 for storing loads 100, typically pallets, comprising a load handling device 1 according to a preferred embodiment of the invention.

The warehouse 200 shown in the figures by way of example has a simple layout and preferably comprises storage aisles 11, 21, 31 arranged laterally with respect to a central aisle 51.

The warehouse 200 also preferably comprises a loading/unloading station 18 for the loads, that is an area on which a load 100 which must be stored in a predetermined compartment of the warehouse 200 is placed, or an area on which a load taken from a compartment of warehouse 200 is placed.

The handling of a load 100 within the warehouse 200 is advantageously carried out by the load handling device 1 according to the invention.

The handling of the load in the warehouse 200 consists, preferably, in handling said load from the loading/unloading station 18 towards and in the aisles 11, 21, 31.

The load handling device 1 according to the invention preferably allows the handling of loads of large dimensions and weights, such as pallets, but other types of articles are not excluded.

The load handling device 1 according to the invention is therefore, in particular, suitable for handling pallets containing articles, for automatically storing the load 100 in a warehouse 200. The load handling device 1 comprises a base frame 6 onto which wheels 10A, 10B, 10C, 10D are rotatably connected, which wheels are suitable for allowing the translation of the load handling device 1 along a storage aisle 11, 21, 31 of the warehouse 200. This base frame 6 therefore defines an inner compartment 67, preferably having a box shape, and extending in height to a much lesser extent than the other two dimensions of width and length.

The load handling device 1 also comprises first handling means 61 arranged inside said base frame 6, in the inner compartment 67, and operatively connected to one or more of said wheels 10B, 10D for achieving the translation of the load handling device 1.

The load handling device 1 comprises one or more operational portions 7 defining a temporary support plane PA for the load 100, and second handling means 62 arranged inside the base frame 6 and operatively connected to such operational portions 7 for moving them with respect to the frame base 6 between a base position and a lifting position spaced vertically, that is in height, with respect to the base position.

In one embodiment, the one or more operational portions 7 comprise a pair of support bars 7a, 7b.

Preferably, first handling means 61 comprise one or more electric motors, associated with one or two of the wheels 10B, 10D. Of the total number of wheels 10A, 10B, 10C, 10D it is preferable that only some of them are driving wheels and that the remaining ones are idlers.

In a preferred embodiment, the device 1 comprises main power supply means 68, or primary power supply means, mounted on board the device itself so as to make the device autonomous and self-powered.

In a preferred embodiment, the main power supply means 68 comprise supercapacitors and/or batteries, for example lithium batteries, positioned in the base frame 6.

In an alternative embodiment, a power supply system for the motors may be provided by means of power bars located on the floor along the aisle and a brush on board the device which, placed in continuous contact with the power bar, transfers the electric power supply energy for the parts on board the device.

According to an embodiment, a central control unit 800 is integrally associated with the base frame 6 of the device 1. The central unit 800 controls all the moving parts of the device 1 and the communication with the sensors. Preferably, the central unit 800 also communicates with a warehouse management unit, on which a warehouse software manages the operation of the warehouse 200 and in particular the movements of the device 20 within the warehouse 10. The communication between the central unit 800 and the warehouse management unit is preferably wireless communication.

The central unit 800 is powered by said main electric power supply means 68.

According to the invention, the base frame 6 of the device 1 consists of sheet elements 150, 160, 170, 180, 190 made of stainless steel joined together by gluing and by means of repositionable fixing means, e.g. screw, rivet or expansion means. This allows for easy construction while ensuring adequate strength and reduced storage space.

According to an embodiment, the sheet elements comprise a bottom sheet 150, a right side sheet 160, a left side sheet 170, a head sheet 180, and a tail sheet 190. Preferably, the base frame is made only from the joining of the bottom sheet 150, the right side sheet 160, the left side sheet 170, the head sheet 180 and the tail sheet 190, without other sheets. It is clear that the load handling device 1, on the other hand, may also comprise a lid and other accessories.

Preferably, the joining of the bottom sheet 150, the right side sheet 160, the left side sheet 170, the head sheet 180 and the tail sheet 190 defines a box shape which contains the inner compartment 67.

Preferably, the right side sheet 160, the left side sheet 170, the head sheet 180 and the tail sheet 190 are all joined to the bottom sheet 150 by gluing, preferably by means of an epoxy glue, which ensures ease of installation and at the same time ensures a mechanical seal even in low temperature environments, such as refrigerating rooms.

According to an embodiment, one or more stiffening rods 151, 152 are fixed to the bottom sheet 150 on a bottom sheet outer side 150′, opposite to a bottom sheet inner side 150″. The bottom sheet inner side 150″ is therefore the side that faces towards the inner compartment 67 of the device 1, whereas the bottom sheet outer side 150′ does not face towards the inner compartment 67.

The stiffening rod(s) 151, 152 contribute(s) to making the bottom sheet adequate to support the mechanical stresses to which it is subjected.

Equivalently, the stiffening rods 151, 152 may be replaced by stiffening ribs or by a reinforced section of the bottom sheet 150, for example having an alternation of promontories and valleys, preferably on the bottom sheet outer side 150′.

In general, in the present disclosure, “outer” or “externally” means any element that is located outside the inner compartment 67.

Preferably, the stiffening rods 151, 152 are mutually spaced apart and preferably arranged substantially along one main dimension of the load handling device 1, for example along the entire length of the device 1.

According to an embodiment, the sheet elements 150, 160, 170, 180, 190 comprise guide portions 152, 154, 162, 174 mutually interlocked to ensure unambiguous coupling between the sheet elements and the correct centering. This is particularly effective in the step of assembling and gluing the sheet elements.

Preferably, in an advantageous manner, the load handling device 1 is not painted at least externally or totally, that is it is totally unpainted both internally and externally.

Furthermore, preferably, the stainless steel of the sheet elements is an austenitic steel X5 CrNi 18-10, according to the standard EN 10088-3:2005.

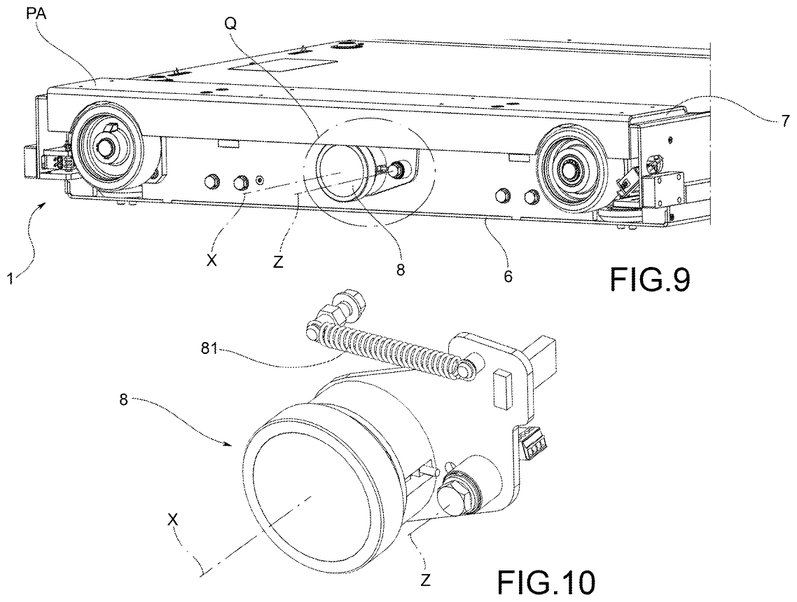

According to an embodiment, the load handling device 1 also comprises a measuring wheel 8, rotatable about a wheel rotation axis X. The measuring wheel 8 is connected to the base frame 6 in a translatable manner along a wheel translation direction incident to the support plane PA or in a rotatable manner about a wheel rotation axis Z parallel to the support plane PA (as for example shown in FIGS. 9 and 10).

Furthermore, the load handling device 1 also comprises a device for detecting the angular position of the measuring wheel 8, for example an electronic encoder (such as an optical position encoder).

In this embodiment, an elastic element 81 is preferably provided, suitable for being elastically deformed during translation of the measuring wheel 8 along the wheel translation direction or during rotation of the measuring wheel 8 about the wheel rotation axis Z, so that the measuring wheel is always in contact with the rails of the warehouse while in operation, while remaining unloaded by the weight of the load 100 (contrary to what happens to the other wheels 10A, 10B, 10C, 10D of the device).

Innovatively, the present invention successfully overcomes the cited drawbacks with respect to the devices of the prior art.

In particular, by virtue of the presence of the base frame assembled by gluing and fixing stainless steel sheet elements with repositionable elements, high reliability and durability over time are guaranteed in synergy with ease of construction and smaller storage and shipping dimensions.

Contrary to the devices of the prior art, in fact, the stainless steel elements do not require painting, greatly reducing the production procedures and therefore the demand for resources. Moreover, in a synergistic manner, a total absence of any risk of corrosion, which is typical of devices of the prior art, is guaranteed, above all in extreme environments, such as refrigerating rooms. This greatly reduces maintenance demands.

Advantageously, the synergistic union between stainless steel elements that do not require painting and the assembly by gluing and repositionable fixing elements allows the frame to be made with sheets with reduced overall dimensions, while guaranteeing improved resistance performance and mechanical reliability.

In particular, the step of storage and shipping of the disassembled sheet elements is enormously more efficient than having to ship and/or store entire heavy, cumbersome and also painted base frames, as happens instead for devices of the prior art.

Furthermore, the total absence of welding in the device according to the present invention avoids the loss of abutments for the assembly of the frame, which instead frequently occurs with the frames of the prior art.

Furthermore, in an advantageous manner, the measuring wheel which is translatable or rotatable with respect to the support plane allows such wheel to always be floating and under pressure in contact with the aisle rails. In this way, contrary to what happens to the other wheels of the device, the measuring wheel does not undergo any elastic deformation due to the weight of the load and, therefore, a high measurement accuracy is guaranteed, irrespective of the weight and type of load supported by the handling device 1.

In order to meet specific needs, a person skilled in the art may make several changes to the embodiments of this invention or substitutions of elements with other functionally equivalent ones.

These variants are also contained within the scope of protection as defined by the following claims.

1. A load handling device for automatically storing a load in a warehouse, said load handling device comprising:
a base frame onto which wheels are rotatably connected, the wheels being suitable for allowing a translation of the load handling device along a storage aisle of the warehouse, said base frame defining an inner compartment;
first handling means arranged inside said base frame in the inner compartment and operatively connected to one or more of said wheels for achieving the translation of the load handling device,
one or more operational portions defining a temporary support plane for said load; and
second handling means arranged inside said base frame and operatively connected to said one or more operational portions for moving said one or more operational portions relative to said base frame between a base position and a lifting position;
wherein the base frame consists of sheet elements made of stainless steel mutually joined by gluing and by repositionable fixing means.

2. The load handling device of claim 1, wherein the sheet elements comprise a bottom sheet, a right side sheet, a left side sheet, a head sheet, and a tail sheet.

3. The load handling device of claim 2, wherein the right side sheet, the left side sheet, the head sheet, and the tail sheet are all joined to the bottom sheet by gluing.

4. The load handling device of claim 2, further comprising one or more stiffening rods fixed to the bottom sheet on a bottom sheet outer side opposite to a bottom sheet inner side, wherein said bottom sheet inner side faces towards the inner compartment, and wherein said one or more stiffening rods are mutually spaced apart.

5. The load handling device of claim 1, wherein the sheet elements comprise guide portions mutually interlocked to ensure unambiguous coupling between the sheet elements and correct centering.

6. The load handling device of claim 1, wherein said load handling device is unpainted.

7. The load handling device of claim 1, further comprising a measuring wheel rotatable about a wheel rotation axis, and connected to the base frame in a translatable manner along a wheel translation direction incident to the temporary support plane or in a rotatable manner about a wheel rotation axis parallel to the temporary support plane; and an angular position detection device for the measuring wheel.

8. The load handling device of claim 7, further comprising at least one elastic element, suitable for being elastically deformed during translation of the measuring wheel along the wheel translation direction or during rotation of the measuring wheel about the wheel rotation parallel to the temporary support plane.

9. The load handling device of claim 1, wherein the stainless steel of the sheet elements is an austenitic steel X5 CrNi 18-10, according to the standard EN 10088-3:2005.

10. The load handling device of claim 1, wherein the load handling device is suitable for handling pallets containing articles.

11. The load handling device of claim 1, wherein the repositionable fixing means are screw, rivet or expansion means.

12. The load handling device of claim 4, wherein the one or more stiffening rods are arranged along a main dimension of the load handling device.
